(19) United States
(12) Patent Application Publication
(10) Pub. No.: US 2008/0129064 A1
(43) Pub. Date: Jun. 5, 2008

(54) BERNOULLI WAND

(75) Inventor: Ellis G. Harvey, Chandler, AZ (US)

Correspondence Address: KNOBBE, MARTENS, OLSEN & BEAR LLP, 2040 MAIN STREET, FOURTEENTH FLOOR, IRVINE, CA, 92614, US

(73) Assignee: ASM AMERICA, INC., Phoenix, AZ (US)

(21) Appl. No.: 11/566,158

(22) Filed: Dec. 1, 2006

(51) Int. Cl. B25J 15/06

(52) U.S. Cl. 294/64.3

(57) ABSTRACT

A Bernoulli wand for transporting semiconductor wafers. The wand has a head portion having a plurality of gas outlets configured to produce a flow of gas along an upper surface of a wafer to create a pressure differential between the upper surface of the wafer and the lower surface of the wafer. The pressure differential generates a lift force that supports the wafer below the head portion of the wand in a substantially non-contacting manner, employing the Bernoulli principle. The wand has independently controllable gas channels configured to provide flow to different sets of gas outlet holes. The gas outlet holes and gas channels are configured to support a wafer using the Bernoulli principle.

### FIELD OF THE INVENTION

The present invention relates to semiconductor substrate handling systems and, in particular, relates to semiconductor substrate pickup devices employing gas flow to lift a substrate using the Bernoulli effect.

### BACKGROUND

Integrated circuits are typically comprised of many semiconductor devices, such as transistors and diodes, which are formed on a thin slice of semiconductor material, known as a wafer. Some of the processes used in the manufacturing of semiconductor devices in the wafer involve positioning the wafer in high temperature chambers where the wafer is exposed to high temperature gases, which result in layers being formed on the wafer. When forming such integrated circuits, it is often necessary to load the wafer into and remove it from a high temperature chamber where the wafer can reach a temperature as high as 1200° C. An example of such a high temperature process is epitaxial chemical vapor deposition, although the skilled artisan will readily appreciate other examples of processing at greater than, e.g., 400° C. However, since the wafer is extremely brittle and vulnerable to particulate contamination, great care must be taken so as to avoid physically damaging the wafer while it is being transported, especially when the wafer is in a heated state.

To avoid damaging the wafer during the transport process, various wafer pickup devices have been developed. The particular application or environment from which the wafer is lifted often determines the most effective type of pickup device. One class of pickup devices, known as Bernoulli wands, is especially well suited for transporting very hot wafers. Bernoulli wands formed of quartz are especially advantageous for transporting wafers between high temperature chambers since metal designs cannot withstand such high temperatures and/or can contaminate wafers at elevated temperatures. The advantage provided by the Bernoulli wand is that the hot wafer generally does not contact the pickup wand, except perhaps at one or more small locators or “feet” positioned outside the wafer edge on the underside of the wand, thereby minimizing contact damage to the wafer caused by the wand. Bernoulli wands for high temperature wafer handling are disclosed in U.S. Pat. No. 5,080,549 to Goodwin et al. and in U.S. Pat. No. 6,242,718 to Ferro et al., the entire disclosures of which are hereby incorporated herein by reference. The Bernoulli wand is typically mounted at the front end of a robot or wafer handling arm.

A typical Bernoulli wand design for transporting wafers in high temperature processes is shown in FIG. 1. As illustrated in FIG. 1, the Bernoulli wand 100 can be formed of quartz, which is advantageous for transporting very hot wafers. Typically, gas flows from a gas source through a central gas channel 102 in the neck 110 of the wand 100. The central gas channel 102 supplies gas to a plurality of gas outlet holes 120 positioned in the head 130 of the wand 100. In particular, when positioned above the wafer, the Bernoulli wand uses jets of gas flowing at angles from the gas outlet holes 120 to create a gas flow pattern above the wafer that causes the pressure immediately above the wafer to be less than the pressure immediately below the wafer, creating the Bernoulli effect. Consequently, the pressure imbalance causes the wafer to experience an upward “lift” force. Moreover, as the wafer is drawn upward toward the wand 100, the same jets that produce the lift force produce an increasingly larger repulsive force that prevents the wafer from contacting the Bernoulli wand 100. As a result, it is possible to suspend the wafer below the wand in a substantially non-contacting manner.

Some of the gas outlet holes 120 are typically biased towards “feet” 140 positioned at one end of the wand 100 to keep the wafer in place under the wand 100. The feet 140 constrain the wafer and prevent the wafer from moving further laterally by contacting the wafer on its edge at two points.

### SUMMARY

In accordance with an embodiment, a semiconductor wafer handling device is provided. The device comprises a head portion and a neck. The head portion has a first set of gas outlets and a second set of gas outlets. The first and second sets of gas outlets are arranged to direct gas flow against a wafer to support the wafer using the Bernoulli effect. The neck has a first end and a second end, and is configured to be connected to a robotic arm on the first end and to the head portion on the second end. The neck includes portions of a plurality of independently controllable gas channels running therethrough. Each of the gas channels is in fluid communication with one of the first and second sets of gas outlets.

In accordance with another embodiment, a semiconductor wafer handling device is provided. The device comprises a head portion, a plurality of wand feet extending from the head portion, and a neck. The head portion has a plurality of gas outlets arranged to direct gas flow against a wafer in a manner to support the wafer using the Bernoulli effect. The neck has a first end and a second end, and is configured to be connected to a robotic arm on the first end and to the head portion on the second end. The neck comprises a plurality of independently controllable gas channels running therethrough. The gas channels are in fluid communication with the plurality of gas outlets and configured for a two-staged biasing of the wafer toward the wand feet.

In accordance with another embodiment, a semiconductor wafer handling device is provided. The device comprises a head portion and a neck. The head portion has a plurality of gas outlets arranged to direct gas flow against a wafer to support the wafer using the Bernoulli effect. The neck has a first end and a second end, and is configured to be connected to a robotic arm on the first end and to the head portion on the second end. The neck comprises a plurality of independently controllable gas channels running therethrough. The gas channels are in fluid communication with the plurality of gas outlets and the gas channels being adjustable to provide gas flow from the gas outlets that does not bias the wafer in a rotational direction.

In accordance with yet another embodiment, a method is provided for transporting a semiconductor wafer. A head portion of a Bernoulli wand is positioned over an upper surface of the wafer, wherein the head portion comprises a plurality of wand feet configured to restrain lateral movement of the wafer. The wafer is supported by drawing the wafer toward the head portion by creating a low pressure zone over the upper surface of the wafer and applying a slight lateral force on the wafer against the wand feet. An additional substantially larger lateral force is applied against the wafer after applying the slight lateral force while supporting the wafer with the low pressure zone, wherein the additional substantially lateral force is greater than the slight lateral force. The wafer is transported in a substantially non-contacting manner while supporting the wafer with the low pressure zone after applying the additional substantially lateral force.

According to another embodiment, a method is provided for transporting a semiconductor wafer. A head portion of a Bernoulli wand is positioned over an upper surface of the wafer. The wafer is supported by drawing the wafer toward the head portion by creating a low pressure zone over the upper surface of the wafer. Wafer rotation is controlled while supporting the wafer, the wafer rotation being in a plane parallel to a major surface of the head portion. The wafer is transported in a substantially non-contacting manner while supporting the wafer with the low pressure zone.

### BRIEF DESCRIPTION OF THE DRAWINGS

These and other aspects of the invention will be readily apparent to the skilled artisan in view of the description below, the appended claims, and from the drawings, which are intended to illustrate and not to limit the invention, and wherein:

FIG. 1 is a schematic plan view of a conventional Bernoulli wand.

FIG. 2A schematically illustrates a wafer transport system comprised of a Bernoulli wand that is configured to engage with a semiconductor wafer, according to an embodiment.

FIG. 2B is a schematic top plan view of the Bernoulli wand of FIG. 2A.

FIG. 2C is a cross-sectional view of an angled gas outlet hole in the lower plate of the head of the Bernoulli wand of FIG. 2A.

FIG. 2D is a side view of the Bernoulli wand of FIG. 2A

FIG. 2E is a side view of the head of the Bernoulli wand of FIG. 2A, illustrating gas flow from the gas outlet holes, according to an embodiment.

FIG. 3A is a schematic underside plan view of a Bernoulli wand, according to another embodiment.

FIG. 3B is a detailed view of adjustable orifices in gas channels of the Bernoulli wand of FIG. 3A.

FIG. 4 is a schematic underside plan view of a Bernoulli wand, according to another embodiment.

FIG. 5A is a schematic plan view of a Bernoulli wand, according to yet another embodiment.

FIG. 5B is a schematic top plan view of the flat head portion of the Bernoulli wand of FIG. 5A between shelves of a cassette.

FIG. 5C is a schematic top and front perspective view of a cassette rack.

FIG. 6 is a schematic diagram of a semiconductor processing system including a Bernoulli wand.

### DETAILED DESCRIPTION OF THE PREFERRED EMBODIMENTS

The following detailed description of the preferred embodiments and methods presents a description of certain specific embodiments to assist in understanding the claims. However, one may practice the present invention in a multitude of different embodiments and methods as defined and covered by the claims.

Referring more specifically to the drawings for illustrative purposes, the present invention is embodied in the devices generally shown in the Figures. It will be appreciated that the apparatuses may vary as to configuration and as to details of the parts, and that the methods may vary as to the specific steps and sequence, without departing from the basic concepts as disclosed herein.

Existing Bernoulli wands, which have a single central gas channel, have been found to be particularly problematic. One problem with these existing Bernoulli wands is that the wand feet cause damage to the edge of the wafer where the edge contacts the feet, as some of the gas outlet holes are biased towards the feet. As mentioned above, wand feet are provided to prevent the wafer from moving laterally away from the Bernoulli wand. Typically, gas flows through the gas outlet holes at a rate such that the gas provides a holding force strong enough to support the wafer using the Bernoulli effect. However, the force applied typically causes the wafer to initially contact the wand feet with too much momentum and force, thus causing damage to the wafer edge. As discussed above, the Bernoulli wand must apply enough holding force to keep the wafer in place under the wand. If too little holding force is provided, the wafer may “bounce” off the wand feet and may sling off (due to centrifugal force) when the Bernoulli wand is rotated to a new position (e.g., the wafer is transported to a new process chamber or into a loadlock chamber).

In particular, wafer manufacturers using Bernoulli wands in machines to pre-coat their wafers with an ultra-pure epitaxial silicon layer often cannot tolerate any damage to the wafer edge. It is also difficult to control the orientations of the gas outlet holes as well as the diameter tolerances of the holes during manufacturing. Even a small variation (e.g., thousandths of an inch) in orientation and/or diameter of the gas outlet holes can cause a wafer to rotate and “bounce” while being supported by the Bernoulli wand, which can adversely affect performance of the wand. To counteract this wafer rotation, the outlet holes of a conventional Bernoulli wand should be sized and angled (balanced side to side) appropriately.

The improved wafer transport system described hereinbelow includes a modified Bernoulli wand made of a material for high temperature processing that minimizes the wafer edge damage problem associated with the wands described above. Suitable materials for the Bernoulli wand include, but are not limited to, ceramic, quartz, and glass. Preferably, such Bernoulli wands can withstand temperatures in a range from room temperature to about 1150° C., and especially in a range from about 400-900° C., and even more importantly in a range from about 300-500° C. The potential damage to the wafer edge due to scratching by the wand feet can be minimized by modifying the wand so that it has multiple, independently controllable gas channels supplying gas to different sets of gas outlets. The wafer transport mechanism described herein may be used in an epitaxial deposition system, but it can also be used in other types of semiconductor processing systems.

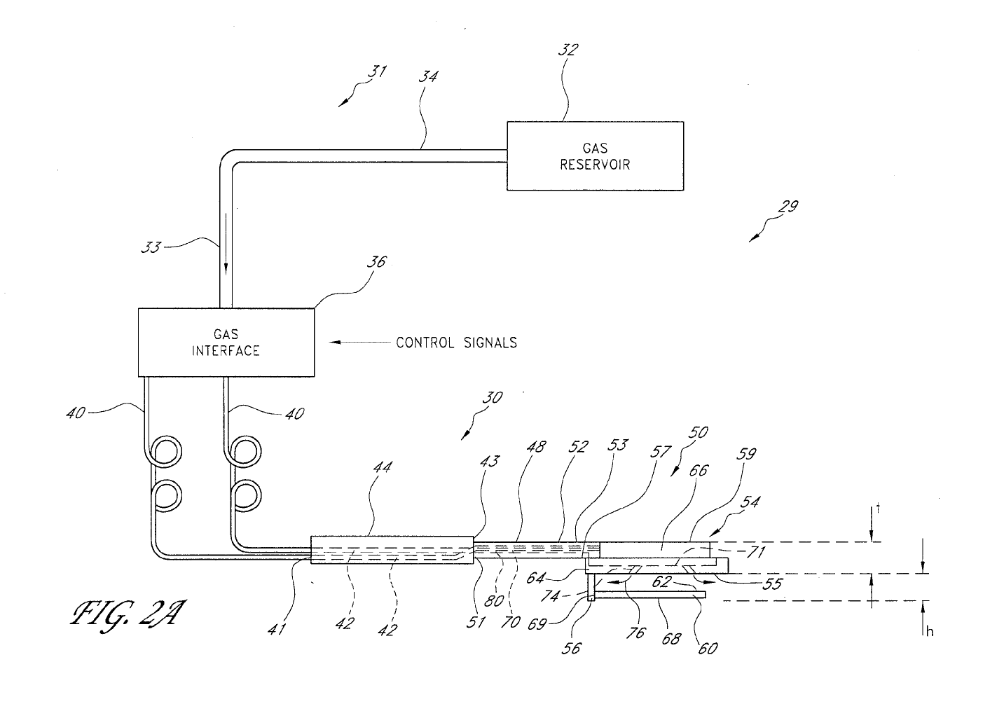

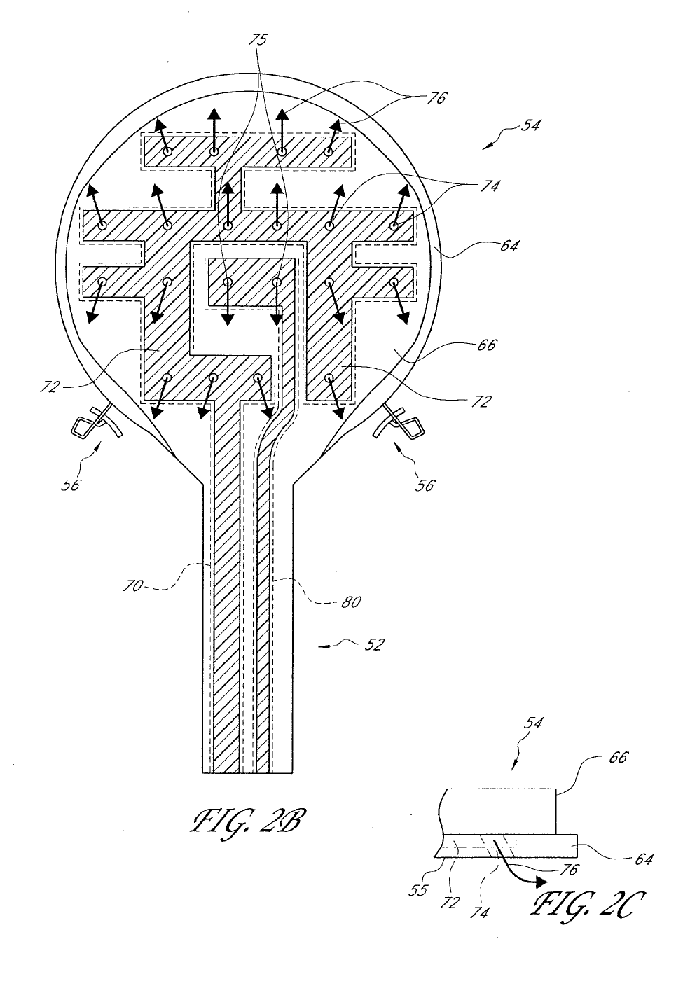

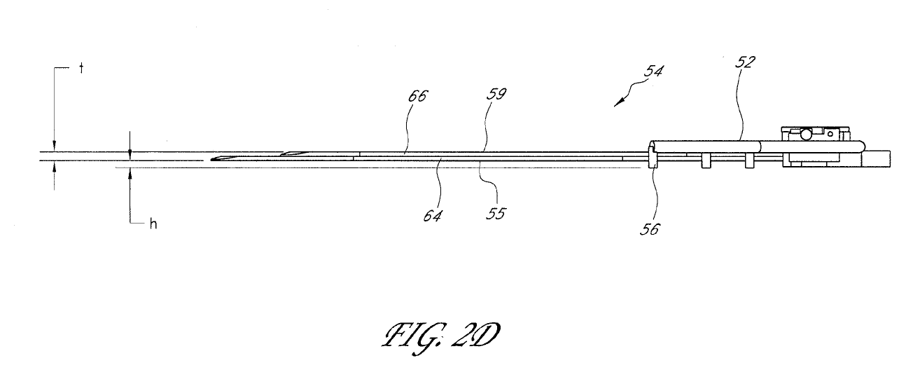

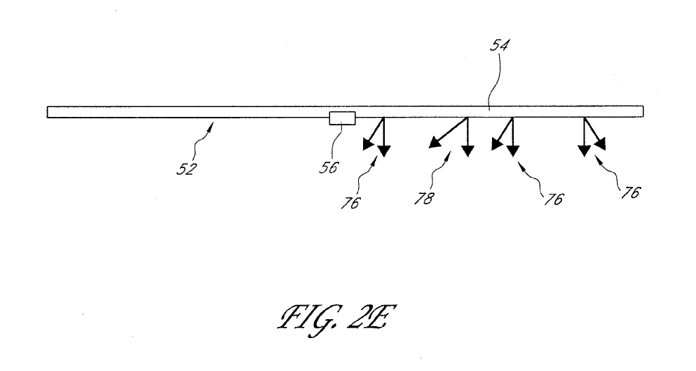

Reference will now be made to the drawings wherein like numerals refer to like parts throughout. FIG. 2A schematically illustrates an embodiment of a semiconductor wafer transport system 29 that is adapted to transport a substantially flat semiconductor wafer 60 into and out of a high temperature chamber. In particular, the wafer transport system 29 comprises a wafer transport assembly 30 having a movable Bernoulli wand 50 that is configured to engage with a wafer 60 for transport in a substantially non-contacting manner. The system 29 further comprises a gas supply assembly 31 that is adapted to supply a flow of inert gas 33, such as nitrogen (N₂), to the wand 50. It will be understood that the Bernoulli wand 50 is typically mounted on a robot, as other end effectors are in the semiconductor processing field.

As shown in FIG. 2A, the gas supply assembly 31 typically comprises a main gas reservoir 32 and a main gas conduit 34 connected thereto. In particular, the reservoir 32 preferably includes an enclosed cavity that is adapted to store a large quantity of gas under a relatively high pressure and a pressure regulator to controllably deliver the flow of gas 33 through the conduit 34 for an extended period of time. Alternatively, a pressurized gas supply may be used in place of a gas reservoir.

In the illustrated embodiment of FIG. 2A, the wafer transport assembly 30 comprises a gas interface 36, two conduits 40, a robotic arm 44 having a proximal or rear end 41, a movable distal or front end 43, and two enclosed gas channels 42 extending therebetween. In particular, the gas interface 36 is adapted to couple with the main gas conduit 34 of the gas supply assembly 31 so as to enable the gas 33 to flow into the robotic arm 44. Moreover, the front end 43 of the robotic arm 44 is adapted to be controllably positioned so as to displace the Bernoulli wand 50 connected thereto in a controlled manner. The skilled artisan will appreciate that the gas interface 36 may include components, such as distribution manifolds, control valves, accumulators, flow controllers, flow meters, gas driers, gas filters, etc.

In the embodiment illustrated in FIG. 2A, the Bernoulli wand 50 includes an elongated neck or rear portion 52, a forward portion or flat head 54, and a plurality of alignment feet 56. The neck 52 includes a first end 51 and a second end 53, an upper surface 48, and an enclosed primary gas channel 70 and secondary gas channel 80 that extend from the first end 51 to the second end 53. Furthermore, the first end 51 of the neck 52 is attached to the front end 43 of the robotic arm 44 to allow the gas 33 to flow from the channel 42 in the robotic arm 44 into the gas channels 70, 80 in the neck portion 52 of the Bernoulli wand 50. Additionally, the second end 53 of the neck portion 52 of the Bernoulli wand 50 is attached to the head 54 of the wand 50 to physically support the head 54 and to allow the gas 33 to flow from the gas channels 70, 80 into the head 54. It will be understood that, in the embodiment illustrated in FIG. 2A, each of the gas channels in the robotic arm 44 is in fluid communication with one of the gas channels 70, 80 of the neck portion 52. In an alternative embodiment, one gas channel 42 in the robotic arm 44 splits into the gas channels 70, 80 in the neck portion 52. The skilled artisan will appreciate that, in this alternative embodiment, there is preferably only one gas conduit 40 fluidly connecting the gas interface 36 with the gas channel 42 in the robotic arm.

As indicated schematically in FIGS. 2A and 2B, the head 54 is formed of a substantially flat upper plate 66 and a substantially flat lower plate 64 that are combined in a parallel manner to form a composite structure having a first end 57, a lower surface 55, and an upper surface 59. Preferably, the head 54 is sized and shaped to cover the entire area of the wafer. In a preferred embodiment, the head 54 is substantially circular. The diameter of the head 54 is preferably about the same as the diameter of the wafer. For example, the head 54 of a wand 50 configured to transport a 200 mm wafer preferably has a diameter of about 200 mm. In some embodiments, the head 54 may have a diameter larger or smaller than the diameter of the wafer. The skilled artisan will appreciate that a head 54 that is too large may interfere with the interface between the head 54 and a rack or cassette, whereas a head 54 that is too small may not provide an adequate Bernoulli effect. Thus, the diameter of the head 54 is preferably within ±5 mm of the diameter of the wafer, and more preferably within ±2 mm of the diameter of the wafer. In some embodiments, the head 54 is not perfectly circular and the diameter along one axis may be greater than the diameter along another axis. The head 54 has a thickness “t” (FIGS. 2A and 2D) preferably of about ⅛-⅜ inch in thickness, and more preferably about 0.120 inch in thickness. In a preferred embodiment, each plate 64, 66 is about 0.060 inch thick.

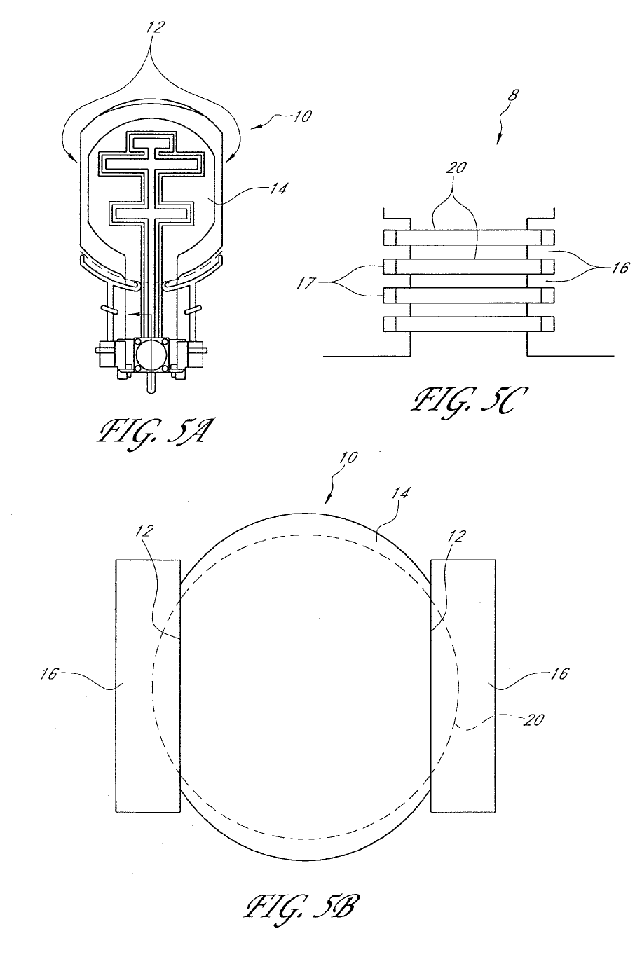

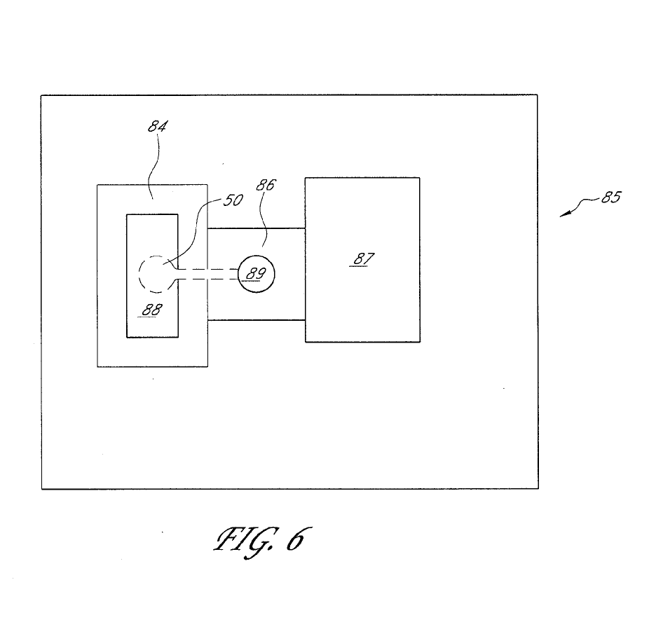

The skilled artisan will understand that, in other embodiments, the head may have truncated sides such that the Bernoulli wand can load and unload wafers from a cassette rack for holding multiple wafers in a multi-wafer processing apparatus. Such a wand 10 is shown in FIG. 5A, with a head portion 14 having truncated sides 12. FIG. 5B is a top plan view of the flat head portion 14 of the Bernoulli wand 10 between shelves 16 of a cassette rack. A typical cassette rack 8 is shown in FIG. 5C. Each slot 17 is capable of holding a wafer 20. Typically, these cassette racks 16 hold, for example, about 26 wafers in a vertical column. As shown in FIG. 5B, the truncated sides 12 allow the Bernoulli wand 10 to be inserted between the shelves 16 of a cassette rack. When the wafer 20 is loaded into a slot 17 (FIG. 5C) of the cassette rack 8, opposite peripheral edges (which are left “uncovered” by the truncated sides 12) of the wafer 20, shown by dotted line 20 in FIG. 5B, are horizontally supported by the shelves 16 of the cassette rack 8 while the Bernoulli wand 10 is inserted between the shelves 16. The Bernoulli wand 10 having the truncated sides 12 is configured such that it can fit between the shelves 16, thereby allowing for a fairly densely stacked cassette rack 8.

Furthermore, since the neck 52, head 54, and feet 56 of the wand 50 are preferably constructed of a high temperature material, such as, for example, quartz or ceramic, the Bernoulli wand 50 is preferably able to extend into a high temperature chamber to manipulate the wafer 60 having a temperature as high as 1150° C., and especially in a range of about 400-900° C., and even more importantly in a range of about 300-500° C., while minimizing damage to the wafer 60. The use of such high temperature materials enables the wand 50 to be used to pick up relatively hot substrates without contaminating the substrate.

FIGS. 2A and 2B illustrate an embodiment of a Bernoulli wand having two separate gas channels 70, 80. The two separate gas channels 70, 80 are preferably independently controllable and each supplies gas to a different set of outlet holes 74, 75. It will be understood that portions of a set of one or more gas channels 70 and portions of a set of one or more gas channels 80 can be provided in the neck 52. As illustrated, the head 54 is supported by and in fluid communication with the neck 52. The head 54 is further adapted to permit the gas 33 to flow to two sets of gas outlet holes 74, 75 (FIG. 2B) that are located on the lower surface 55 (FIG. 2A) of the head 54, as will be described below. The primary set of gas outlet holes 74 are supplied gas from the primary gas channel 70. The secondary set of gas outlet holes 75 are supplied gas from the secondary gas channel 80. As illustrated in FIG. 2B, the secondary set of gas outlet holes 75 are in the center of the lower surface 55 of the head 54 and the primary set of gas outlet holes 74 are arranged around the secondary set of gas outlet holes 75.

As shown in FIG. 2B, the head 54 further includes a plurality of enclosed distribution channels 72 that extend from the primary gas channel 70. The distribution channels 72 and primary gas channel, together, form a first gas channel set. The primary gas channel 70 supplies gas to the primary set of gas outlet holes 74 via these distribution channels 72, as shown in FIG. 2B. The secondary gas channel 80 supplies gas to the secondary set of gas outlet holes 75, which comprises two gas outlet holes in the illustrated embodiment. The skilled artisan will understand that the secondary set of gas outlet holes 75 may comprise more than two outlet holes in alternative embodiments. It will be understood that, in other embodiments, there may be a plurality of distribution channels extending from the secondary gas channel 80, which may supply gas to the secondary set of gas outlet holes 75. It will be understood that such a plurality of distribution channels extending from the secondary gas channel 80, together with the secondary gas channel 80, would form a second gas channel set.

In the head portion 54, the primary and secondary channels 70, 80 and each of the distribution channels 72 are formed as grooves in the upper surface of the lower plate 64 of the head 54, as shown in FIG. 2B. Alternatively, the primary and secondary channels 70, 80 and the plurality of distribution channels 72 may be formed in the lower surface of the upper plate 66.

The gas flow through the primary gas channel 70 to the first set of gas outlet holes 74 preferably provides enough force to hold the wafer 62 to the wand 50, using the Bernoulli effect. The first set of gas outlet holes 74 is angled and distributed such that the gas outlet holes 74 extend through the lower plate 64 from the distribution channels 72 to the lower surface 55 (FIG. 2A) of the head 54 so as to produce a generally radially outwardly directed gas flow 76 therefrom over the wafer, as shown in FIGS. 2A-2C. The skilled artisan will understand that this general pattern of the angled gas flow from the first set of gas outlet holes 74 results in the Bernoulli effect. Furthermore, the gas supplied to the first set of gas outlet holes 74 preferably provides a small bias toward the wand feet 56, as described in further detail below.

The secondary gas channel 80 supplies a second set of gas outlet holes 75 that are preferably highly biased toward the wand feet 56. As shown in the simplified representation of FIG. 2E, the second set of gas outlet holes 75 are angled to produce a more biased flow 78 toward the wand feet 56, as explained in more detail below. The skilled artisan will readily appreciate that the gas flowing from the second set of gas outlet holes 75 contributes to the Bernoulli effect created by the gas flowing from the first set of gas outlet holes 74.

As discussed above, the primary and secondary gas channels 70, 80 are preferably independently controllable. According to this embodiment, the gas flow to the primary gas channel 70 is preferably turned on before the gas flow to the secondary gas channel 80. When the former is on and the latter is off, and when the wand 50 is positioned above the wafer 60 having a flat upper surface 62 and a flat lower surface 68, the wafer 60 becomes engaged with the wand 50 in a substantially non-contacting manner, as shown in FIG. 2A. In particular, as shown in FIGS. 2A and 2B, the gas flow 76 from the first set of outlet holes 74 shoots generally horizontally and generally radially outwardly across the upper surface 62 of the wafer 60 from above, creating a low pressure zone over the wafer 60 where the pressure above the wafer 60 is less than the pressure below the wafer 60. Thus, in accordance with the Bernoulli effect, the wafer 60 experiences an upward “lift” force and is drawn toward the head portion 54. The skilled artisan will readily appreciate that, as described above, in some embodiments, there are two gas channels 42 in the robotic arm 44, each being connected on one end to one of the gas channels 70, 80 and each being connected on the other end to a separate gas interface 36 or gas supply, which can be separately turned on. Valves or other restrictors may be provided on the gas channels 42 in the robotic arm 44 or on gas channels 70, 80 in the neck 52 to independently control the gas flow through the gas channels 70, 80.

As mentioned above, the gas flow 76 produces a pressure imbalance and consequent upward force that causes the wafer 60 to be subsequently displaced to an equilibrium position, wherein the wafer 60 levitates below the head 54 substantially without contacting the head 54. In particular, at the vertical equilibrium position, the downward reactive force acting on the wafer 60 caused by the gas flow 76 impinging the upper surface 62 of the wafer 60 and the gravitational force acting on the wafer 60 combine to offset the lift force produced by the pressure imbalance. Consequently, the wafer 60 levitates below the head 54 at a substantially fixed vertical position with respect to the head 54. Furthermore, while the wafer 60 is engaged by the head 54 in the foregoing manner, the plane of the wafer 60 is oriented to be substantially parallel to the plane of the head 54. Moreover, the distance between the upper surface 62 of the wafer 60 and the lower surface 55 of the head 54 is typically small in comparison with the diameter of the wafer 60. This distance is preferably in the range of about 0.008-0.013 inch.

To prevent the wafer 60 from moving in a horizontal manner, the first set of gas outlet holes 74 is preferably distributed and angled to impart a slight lateral bias to the gas flow 76 that causes the wafer 60 to gently travel toward the feet 56 of the wand 50. According to an embodiment, the feet have a height “h” (FIG. 2D) of about 0.08 inch from the lower surface 55 of the wand 50. Consequently, an edge surface 69 (FIG. 2A) of the wafer 60 gently engages with the feet 56 to prevent further lateral movement of the wafer 60 with respect to the wand 50, and also to substantially prevent any damage to the wafer edge 69.

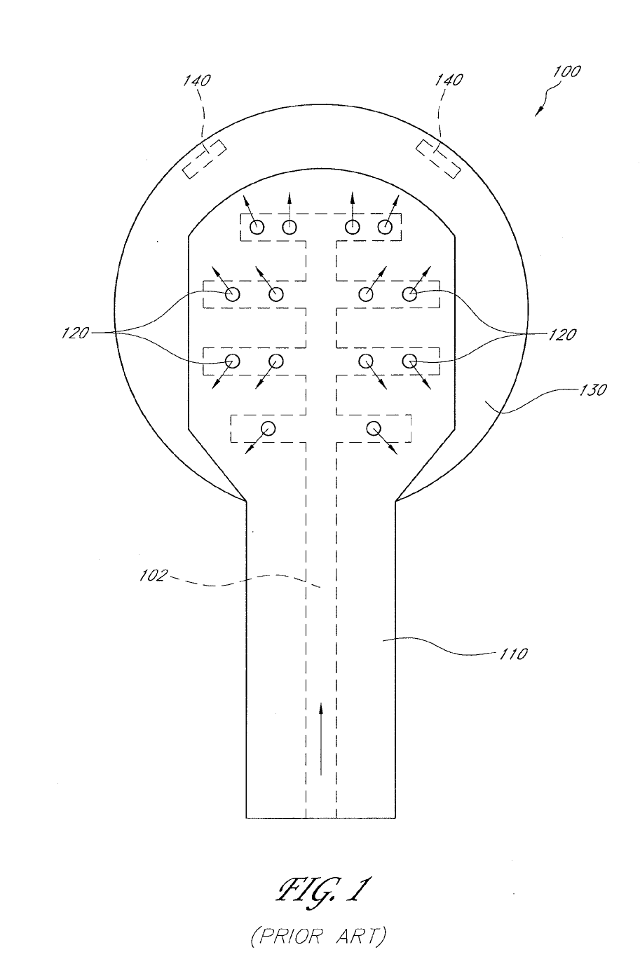

The skilled artisan will understand that the feet may be positioned on either end of the head 54 to prevent further lateral movement of the wafer 60 with respect to the wand 50. In some embodiments, as shown in FIGS. 2A, 2B, 2D, and 2E the feet 56 are positioned at the proximal end of the head 54. In other embodiments, as shown in FIG. 1 (which is not an embodiment of the invention, but shows the feet 140, which can be provided in embodiments of the invention), the feet 56 are positioned at the distal end of the head. It will be understood that if the wand 50 is used with a rack, such as a cassette, the feet 56 are preferably positioned at the proximal end of the head 54, as illustrated in FIGS. 2A, 2B, 2D, and 2E. The skilled artisan will appreciate that the feet may be positioned at the distal end of the head if the wand 50 is not used with a rack. The feet 56 are preferably also formed of high temperature material, such as quartz.

In operation, as described above, the gas flow to the primary gas channel 70 is preferably turned on first (i.e., before turning on gas flow through the secondary gas channel 80), drawing the wafer 60 upward toward the wand 50 and gently pushing the wafer 60 laterally against the wand feet 56. After a predetermined time, preferably in the range of about one to five seconds, and more preferable about two seconds, while gas continues to flow from the first set of gas outlet holes 74, gas flow to the secondary gas channel 80 is turned on to contribute to the Bernoulli effect caused by gas flowing from the first set of gas outlet holes 74 and also to provide an additional substantially lateral holding force of the wafer 60 against the wand feet 56. As discussed above, the second set of gas outlet holes 75 is angled such that the gas outlet holes 75 are highly biased toward the wand feet 56. As the wafer edge 69 was already in contact with the wand feet 56 (due to the slight bias provided by the gas flowing from the first set of gas outlet holes 74), this additional force from the secondary gas channel 80 does not cause additional damage to the wafer edge 69 as there is no hard impact, but the additional force more strongly retains the wafer against the feet 56. This allows the wafer 60 to be transported by the Bernoulli wand 50 (e.g., to another station) with a significantly reduced danger of the wafer 60 falling off due to centrifugal force when the wand 50 is rotated.

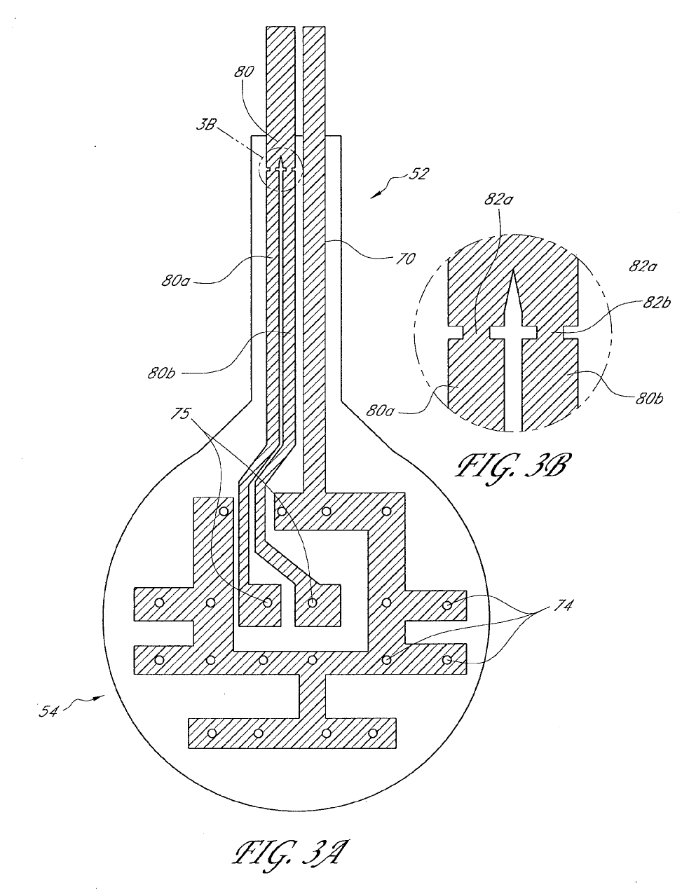

FIG. 3A is a schematic bottom plan view of a second embodiment of the Bernoulli wand 50. As shown in FIG. 3A, this embodiment of the Bernoulli wand 50 has three gas channels, comprising one primary gas channel 70, and two secondary channels 80a, 80b. This embodiment is similar to the wand shown in FIGS. 2A-2E, except that the secondary channel 80 becomes divided into a left branch 80a and a right branch 80b. The amount of flow through the left and right branches 80a, 80b can be controlled by adjusting the orifices 82a, 82b (see FIG. 3B) so that gas flow from the gas outlet holes 74, 75 can be adjusted to be symmetrical or balanced with respect to the gas flowing from the left and right branches 80a, 80b, thereby reducing the problematic wafer rotation discussed above. Thus, small variations (described above) in the sizes and orientations of the gas outlet holes 74, 75 can be corrected by adjusting the relative gas flow through the left and right branches 80a, 80b to provide a symmetrical or balanced flow to reduce wafer rotation.

As shown in FIG. 3B, each of the left and right branches 80a, 80b is provided with an adjustable orifice 82a, 82b. The relative flow between the left and right branches 80a, 80b can be adjusted by using a small, gradually enlarging restricting means on one side or the other to adjust the flow to be symmetric or balanced. To increase the holding force toward the wand feet 56 without affecting the symmetry of the flow, both orifices 82a, 82b could be enlarged at the same rate until the required force is achieved. The skilled artisan will appreciate that a restricting means, such as a valve or a restrictor, can be used to control the flow through the orifices 82a, 82b and that the gas interface 36 may control the flow through the primary channel 70.

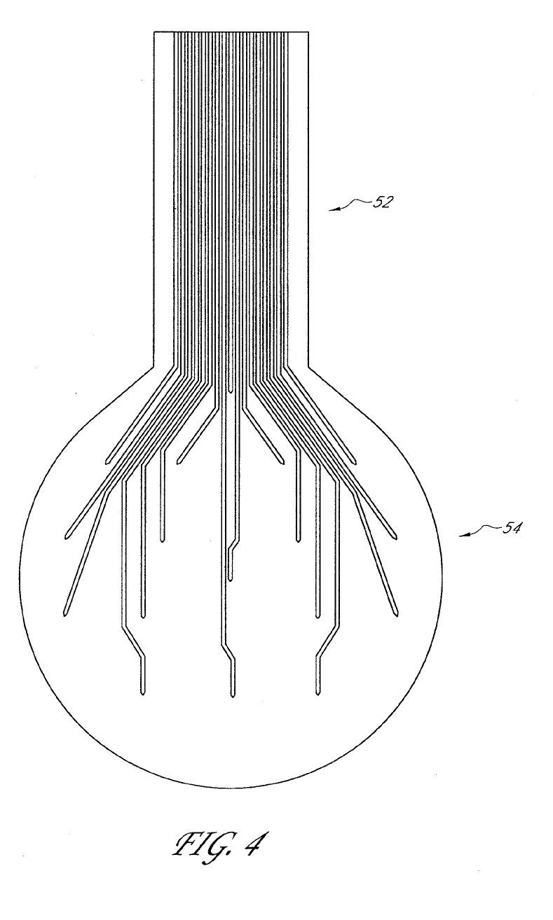

A third embodiment is shown in FIG. 4. In this embodiment, a separate gas channel is provided for each individual outlet hole. The skilled artisan will readily appreciate that, in this embodiment, the flow through each outlet hole can be controlled independently such that the flow may be finely tuned. It will be understood that this embodiment may be provided with any number of gas channels and corresponding gas outlet holes.

One embodiment of a semiconductor processing system 85 is illustrated in FIG. 6. FIG. 6 is a schematic overhead diagram showing a section of the semiconductor processing system 85. A load port or a loadlock chamber 84 is preferably joined with a wafer handling chamber (WHC) 86, as shown in FIG. 6. In the illustrated embodiment, the Bernoulli wand 50 is connected to a WHC robot 89 that resides within the WHC 86. The Bernoulli wand 50 is configured to access wafers within a rack or cassette 88 configured to hold wafers for transport from the load port or loadlock chamber 84 to a process chamber 87, where a wafer may be processed on a susceptor, in accordance with this embodiment. Accordingly, the Bernoulli wand 50 can reach into the slots for loading and unloading wafers.

The skilled artisan will understand that, in other embodiments, there may be a plurality of process chambers 87 and/or loadlock chambers 84 adjacent to the WHC 86, and the WHC robot 89 and Bernoulli wand 50 may be positioned to have effective access to the interiors of all of the individual process chambers and cooling stations without the need to interact with a rack. In such a system, a separate end effector (e.g., a paddle) can be provided to interact with a rack. The process chambers 87 may be used to perform the same process on wafers. Alternatively, as the skilled artisan will appreciate, the process chambers 87 may each perform a different process on the wafers. The processes include, but are not limited to, sputtering, chemical vapor deposition (CVD), etching, ashing, oxidation, ion implantation, lithography, diffusion, and the like. Each process chamber 87 typically contains a susceptor, or other substrate support, for supporting a wafer to be treated within the process chamber 87. The process chamber 87 may be furnished with a connection to a vacuum pump, a process gas injection mechanism, and exhaust and heating mechanisms. The rack 88 can be a portable cassette or a fixed rack within the loadlock chamber 84.

Although this invention has been disclosed in the context of certain preferred embodiments and examples, it will be understood by those skilled in the art that the present invention extends beyond the specifically disclosed embodiments to other alternative embodiments and/or uses of the invention and obvious modification thereof. Thus, it is intended that the scope of the present invention herein disclosed should not be limited by the particular disclosed embodiments described above, but should be determined only by a fair reading of the claims that follow.

What is claimed is:

1. A semiconductor wafer handling device, comprising:
a head portion having a first set of gas outlets and a second set of gas outlets, the first and second sets of gas outlets being arranged to direct gas flow against a wafer to support the wafer using the Bernoulli effect;
a neck having a first end and a second end, the neck being configured to be connected to a robotic arm on the first end and to the head portion on the second end, wherein the neck includes portions of a plurality of independently controllable gas channels running therethrough, each of the gas channels being in fluid communication with one of the first and second sets of gas outlets.

2. The semiconductor wafer handling device of claim 1, wherein the plurality of independently controllable gas channels comprises a first gas channel set and a second gas channel set, the first gas channel set in fluid communication with the first set of gas outlets and the second gas channel set in fluid communication with the second set of gas outlets.

3. The semiconductor wafer handling device of claim 1, wherein the first set of gas outlets is arranged to provide a generally radially outwardly directed flow of gas.

4. The semiconductor wafer handling device of claim 2, wherein the first gas channel set is configured to supply gas to each of the gas outlets of the first set of gas outlets.

5. The semiconductor wafer handling device of claim 2, further comprising a plurality of wand feet, wherein the first gas channel set and first set of gas outlets are configured to provide gas at a first force for biasing the wafer toward the plurality of wand feet.

6. The semiconductor wafer handling device of claim 5, wherein the second set of gas outlets and second gas channel set are configured to provide gas at a second force for biasing the wafer toward the plurality of wand feet, the second force being greater than the first force.

7. The semiconductor wafer handling device of claim 2, wherein the second gas channel set comprises a first branch and a second branch, the first and second branches having adjustable flow orifices for controlling gas flow rates through the first and second branches.

8. The semiconductor wafer handling device of claim 7, wherein the adjustable flow orifices are configured to provide a balanced gas flow from the second set of gas outlets, the gas flow being balanced between the first gas channel set and the second gas channel set.

9. The semiconductor wafer handling device of claim 7, wherein the second set of gas outlets includes at least one outlet connected to the first branch and configured to direct gas in a direction to bias the wafer in a first rotational direction, the second set of outlets also including at least one outlet connected to the second branch and configured to direct gas in a direction to bias the wafer in a second rotational direction opposite the first rotational direction.

10. The semiconductor wafer handling device of claim 7, wherein the first and second branches are configured for controlling wafer rotation while the wafer is supported using the Bernoulli effect, the wafer rotation being in a plane parallel to a major surface of the head portion.

11. The semiconductor wafer handling device of claim 7, wherein each of the first and second branches comprises an adjustable orifice configured for controlling gas flow rates through the first and second branches.

12. The semiconductor wafer handling device of claim 1, wherein head portion and neck are formed of a high temperature material.

13. The semiconductor wafer handling device of claim 12, wherein the high temperature material is quartz.

14. A semiconductor wafer handling device, comprising:
a head portion having a plurality of gas outlets arranged to direct gas flow against a wafer in a manner to support the wafer using the Bernoulli effect;
a plurality of wand feet extending from the head portion; and
a neck having a first end and a second end, the neck being configured to be connected to a robotic arm on the first end and to the head portion on the second end, wherein the neck comprises a plurality of independently controllable gas channels running therethrough, the gas channels being in fluid communication with the plurality of gas outlets and configured for a two-staged biasing of the wafer toward the wand feet.

15. The semiconductor wafer handling device of claim 14, wherein the plurality of gas outlets comprises a first set of gas outlets and a second set of gas outlets, the first set of gas outlets being angled to direct gas across an upper surface of the wafer and substantially radially outwardly to a periphery of the wafer to create a pressure above the wafer which is less than a pressure below the wafer, wherein the first set of gas outlets is configured to impart a slight bias toward the wand feet.

16. The semiconductor wafer handling device of claim 15, wherein the second set of gas outlets is angled to provide a flow biasing the wafer toward the wand feet, the flow from the second set of gas outlets being biased toward the wand feet more than the flow from the first set of gas outlets.

17. The semiconductor wafer handling device of claim 15, wherein the plurality of gas channels comprises a first gas channel set and a second gas channel set, the first set of gas outlets being in fluid communication with the first gas channel set and the second set of gas outlets being in fluid communication with the second gas channel set.

18. The semiconductor wafer handling device of claim 14, wherein each gas channel is separately controlled.

19. The semiconductor wafer handling device of claim 14, wherein each gas channel is in fluid communication with a separate set of gas outlets.

20. The semiconductor wafer handling device of claim 14, wherein the head portion is formed of quartz.

21. The semiconductor wafer handling device of claim 14, wherein the wand feet are positioned at a distal or proximal end of the head portion.

22. A semiconductor wafer handling device, comprising:
a head portion having a plurality of gas outlets arranged to direct gas flow against a wafer to support the wafer using the Bernoulli effect; and
a neck having a first end and a second end, the neck being configured to be connected to a robotic arm on the first end and to the head portion on the second end, wherein the neck comprises a plurality of independently controllable gas channels running therethrough, the gas channels being in fluid communication with the plurality of gas outlets, the gas channels being adjustable to provide a gas flow from the gas outlets that does not bias the wafer in a rotational direction.

23. The semiconductor wafer handling device of claim 22, further comprising a plurality of wand feet positioned on the head, the wand feet configured to restrain lateral movement of the wafer

24. The semiconductor wafer handling device of claim 23, wherein the wand feet are positioned at a distal or proximal end of the head.

25. The semiconductor wafer handling device of claim 22, wherein a first of the gas channels is in fluid communication with a first set of the gas outlets and a second of the gas channels is in fluid communication with a second set of the gas outlets.

26. The semiconductor wafer handling device of claim 25, wherein the first set of gas outlets is configured to supply a generally radially outwardly directed gas flow.

27. The semiconductor wafer handling device of claim 25, wherein the second gas channel comprises a first branch and a second branch, wherein the first branch is configured to supply gas to at least one outlet configured to direct the gas in a direction that biases the wafer in a first rotational direction, and the second branch is configured to supply gas to at least one outlet configured to direct gas in a direction that biases the wafer in a second rotational direction that is opposite to the first rotational direction, the first and second branches being configured to adjust relative gas flow through the first and second branches.

28. The semiconductor wafer handling device of claim 27, wherein each of the first and second branches comprises a restricting means.

29. The semiconductor wafer handling device of claim 28, wherein the restricting means is a valve.

30. The semiconductor wafer handling device of claim 22, wherein the head portion and neck comprise quartz.

31. A method of transporting a semiconductor wafer, comprising:
positioning a head portion of a Bernoulli wand over an upper surface of the wafer, wherein the head portion comprises a plurality of wand feet configured to restrain lateral movement of the wafer;
supporting the wafer by drawing the wafer toward the head portion by creating a low pressure zone over the upper surface of the wafer and applying a slight lateral force on the wafer against the wand feet;
applying an additional substantially lateral force against the wafer after applying the slight lateral force while supporting the wafer with the low pressure zone, wherein the additional substantially lateral force is greater than the slight lateral force; and
transporting the wafer in a substantially non-contacting manner while supporting the wafer with the low pressure zone after applying the additional substantially lateral force.

32. The method of claim 31, wherein a pressure in the low pressure zone over the wafer is lower than a pressure below the wafer.

33. The method of claim 31, wherein creating the low pressure zone comprises flowing gas generally radially outwardly across the upper surface of the wafer.

34. The method of claim 33, wherein creating the low pressure further comprises flowing gas through a first set of gas outlet holes in a lower surface of the head portion.

35. The method of claim 34, wherein applying the additional substantially lateral force comprises flowing gas through a second set of gas outlet holes in the lower surface of the head portion.

36. The method of claim 31, wherein drawing the wafer comprises biasing the wafer toward the feet such that only an edge of the wafer contacts the feet while transporting the wafer.

37. The method of claim 36, wherein the additional substantially lateral force is applied while the edge of the wafer is contacting the feet.

38. The method of claim 31, wherein the wand feet are positioned on a distal or proximal end of the head portion.

39. The method of claim 31, wherein the head portion is formed of a material for high temperature processing.

40. A method of transporting a semiconductor wafer, comprising:
positioning a head portion of a Bernoulli wand over an upper surface of the wafer;
supporting the wafer by drawing the wafer toward the head portion by creating a low pressure zone over the upper surface of the wafer;
controlling wafer rotation while supporting the wafer, the wafer rotation being in a plane parallel to a major surface of the head portion; and
transporting the wafer in a substantially non-contacting manner while supporting the wafer with the low pressure zone.

41. The method of claim 40, wherein controlling wafer rotation comprises adjusting gas flow from the head portion to the wafer so that the gas flow does not impart a rotational bias to the wafer.

42. The method of claim 40, wherein supporting the wafer comprises flowing gas from a first gas channel through a first set of gas outlets of the head portion and wherein controlling wafer rotation comprises flowing gas from a second gas channel through a second set of gas outlets of the head portion.

43. The method of claim 42, wherein the second gas channel comprises a first branch and a second branch, each of the first and second branches supplying gas to separate gas outlets, and wherein controlling wafer rotation comprises adjusting relative gas flow between the first and second branches.

44. The method of claim 43, wherein adjusting comprises adjusting a valve.

45. The method of claim 40, wherein the head portion is formed of a material for high temperature processing.
